(19) United States
(12) Patent Application Publication
(10) Pub. No.: US 2005/0110741 A1
(43) Pub. Date: May 26, 2005

(54) Apparatus and method for tuning a plurality of contrast voltages for a liquid crystal display

(76) Inventors: Tien-Wen Pao, Hsinchu City (TW); Yao-Hung Fang, Shinhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/973,278

(22) Filed: Oct. 27, 2004

(30) Foreign Application Priority Data
Oct. 28, 2003 (TW) 092129918

(51) Int. Cl. G09G 3/36

(52) U.S. Cl. 345/102

(57) ABSTRACT

An apparatus and method for tuning a plurality of contrast voltages for a liquid crystal display comprises determining an offset by a configuration of a plurality of pins, combining the offset with an original setting to determine a summation, and generating a reference for the plurality of contrast voltages based on the summation.

### FIELD OF THE INVENTION

The present invention relates generally to the generation of the contrast voltages for a liquid crystal display (LCD), and more particularly, to an apparatus and method for tuning the contrast voltages for an LCD by configuring a plurality of pins.

### BACKGROUND OF THE INVENTION

For each LCD module, the contrast voltages thereof have to be tuned before out of the factory, so as to achieve an optimized contrast performance of displaying images. However, even in a batch production of LCD panels, there will not be identical optical and electric characteristics among them because of the process drift and variation, and therefore, the tuning operation for the contrast voltages of the LCD modules is preformed one by one depending on each specific panel of them. For tuning the contrast strength of an LCD module, it is to tune the reference for the contrast voltages or the standard display voltage, typically referred by voltage V0, and this is done by setting the value stored in the display volume register, usually called DV register, of the LCD driver ICs on the module. Generally, the specific value for setting the DV register to obtain an optimized contrast performance is determined by the system integrator in the stage of developing the program for the LCD module, and then programming the developed program into a micro-controller in the LCD module. However, the tuning operation should be still performed for each LCD module, owing to the possible drift of the reference V0 in each LCD panel that will spread the LCD modules out of the optimized contrast with an identical setting of the DV register. Currently, the procedure of this tuning operation is to change the setting of the DV register in each LCD module that is not yet optimized in its contrast, followed by repeated tests and adjustments. After the contrast is optimized, the modified program is programmed into this module. The LCD modules are tuned one by one by such procedure, which is not only annoying and time wasting, but also results in prolonged the product development time and reduced yield, due to such a long-winded process for the individual adjustment.

Accordingly, it is desired an apparatus and method for simple and fast tuning of the contrast voltages for an LCD without individual program modification.

### SUMMARY OF THE INVENTION

An object of the present invention is to provide an apparatus and method for tuning the contrast voltages for an LCD by a simpler and faster process.

Another object of the present invention is to provide an apparatus and method for tuning the contrast voltages for an LCD to allow higher yield thereof by simplified the tuning process.

In an apparatus and method for tuning a plurality of contrast voltages for an LCD, according to the present invention, a plurality of pins are configured to determine an offset, and a variable voltage generator generates a reference for the contrast voltages based on a summation of the offset and an original setting.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a block diagram of an apparatus 10 according to the present invention for tuning the contrast voltages for an LCD;

FIG. 2 shows a simple diagram of the connection between the plurality of pins 12 and offset register 14 of the apparatus 10 shown in FIG. 1;

FIG. 3 shows a diagram of a typical LCD module;

FIG. 4 shows various embodiments for the pin option circuit 13 to determine the configuration of the pins CV1-CVn; and

FIG. 5 shows an example for the circuit shown in FIG. 4A to tune the reference V0 by configuring the pins CV1-CV4.

### DETAILED DESCRIPTION OF THE INVENTION

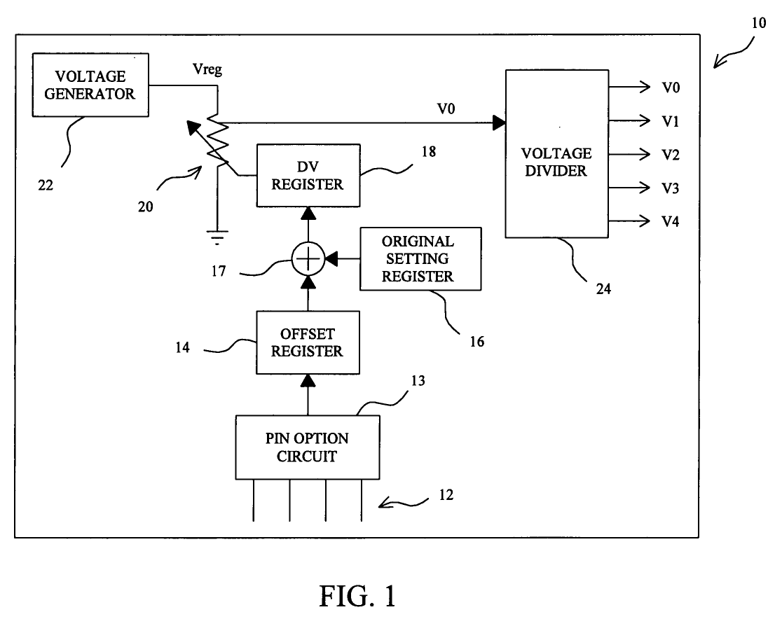

FIG. 1 shows a block diagram of an apparatus 10 for tuning the contrast voltages V0-V4 for an LCD, which comprises a plurality of pins 12 to be configured to determine an offset for the reference V0 of the contrast voltages V0-V4 of the LCD, a pin option circuit 13 connected to the plurality of pins 12 to determine an initial configuration of the plurality of pins 12, an offset register 14 connected with the pin option circuit 13 to store the offset, an original setting register 16 to store an original setting of the DV value for the LCD, a combiner 17 to generate the summation of the offset from the register 14 and the original setting from the register 16, a DV register 18 to store the summation from the combiner 17, a variable resistor 20 has a resistance tuned by the summation stored in the DV register 18, and a voltage source 22 to supply a voltage Vreg to the variable resistor 20 to generate the reference V0. To generate the contrast voltages V0-V4, it is further comprised a voltage divider 24 to divide the reference V0 to generate the contrast voltages V0-V4. As a result, with an appropriate configuration for the offset, the contrast performance of the LCD may be optimized. To determine the offset, each of the plurality of pins 12 is designed to be selectively one of two states of 0 and 1, of three states of 0, 1 and floating, or of a plurality of states, and jumpers are used on the LCD module to determine the state of each of the plurality of pins 12.

For tuning the contrast voltages V0-V4, it is to tune the reference VO, and which is achieved by setting the value of the DV register 18. Since the value stored in the DV register 18 is the summation of the offset from the offset register 14 and the original setting from the original setting register 16, the range and resolution for the reference V0 to be tuned is determined by the configuration of the plurality of pins. In this embodiment, four pins are illustrated for the plurality of pins 12, and thus, if two states are available for each pin of them, up to a four-bit tuning value may be provided for the DV register 18. A four-bit tuning value of the offset will induce sixteen (2⁴) steps of voltages to be selected for the reference V0. If the number of the pins 12 is n, and each pin is switchable between two states, then there will be up to 2ⁿ voltages for the reference V0 to select therefrom.

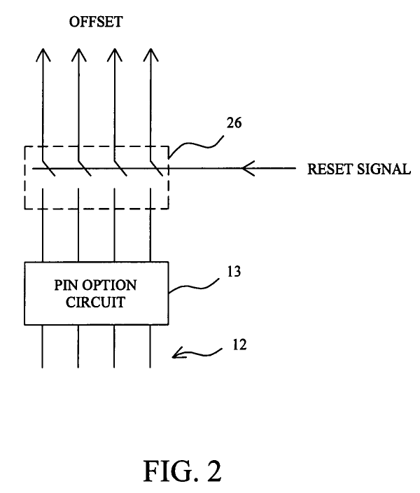

FIG. 2 shows a simple diagram of the connection between the plurality of pins 12 and offset register 14. The pin option circuit 13 is connected with the plurality of pins 12 to determine the initial configuration of the plurality of pins 12, and a switch 26 is inserted between the pin option circuit 13 and the offset register 14, which is switched by a reset signal of a positive or negative impulse to transfer the offset from the pin option circuit 13 to the offset register 14. Upon the reset signal, the switch 26 is turned on or turned off. Once the plurality of pins 12 are configured, the switch 26 may be turned on to transfer the offset determined by the configuration of the plurality of pins 12 to be stored into the offset register 14.

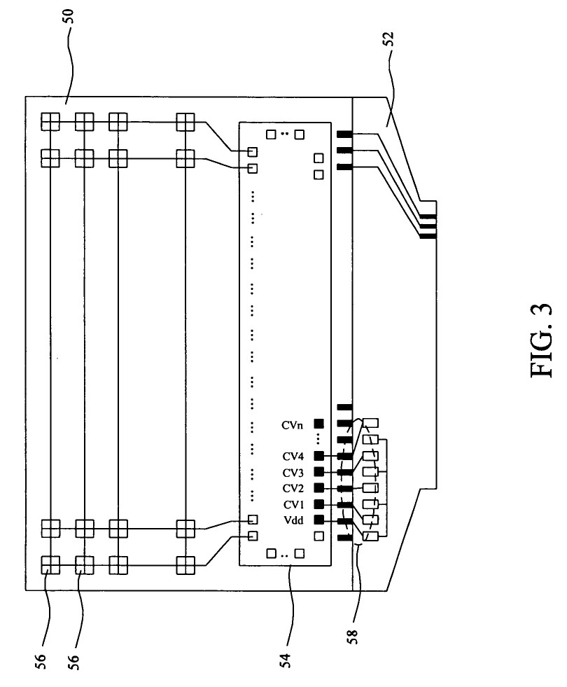

FIG. 3 shows a diagram of a typical LCD module, which comprises a panel 50 and a flexible interface 52. The flexible interface 52 is connected between the LCD module and other equipment, such as a main board of a notebook, a PDA or a mobile phone. The panel 50 is attached with a driver 54 thereon, and the driver 54 has a plurality of outputs connected to the pixels 56 of the switching array on the panel 50 to drive the pixels of the LCD to display images. The driver 54 is a chip having pins CV1-CVn whose states are determined by jumpers 58 and read by the pin option circuit 13. Therefore, the jumpers 58 can define the configuration of the pins CV1-CVn to directly tune the contrast voltages within a short time for an optimized contrast performance of the LCD module, which is a simpler, fast and more convenient process than modification and programming of software for the driver 54. The throughput and yield of the LCD modules are also increased.

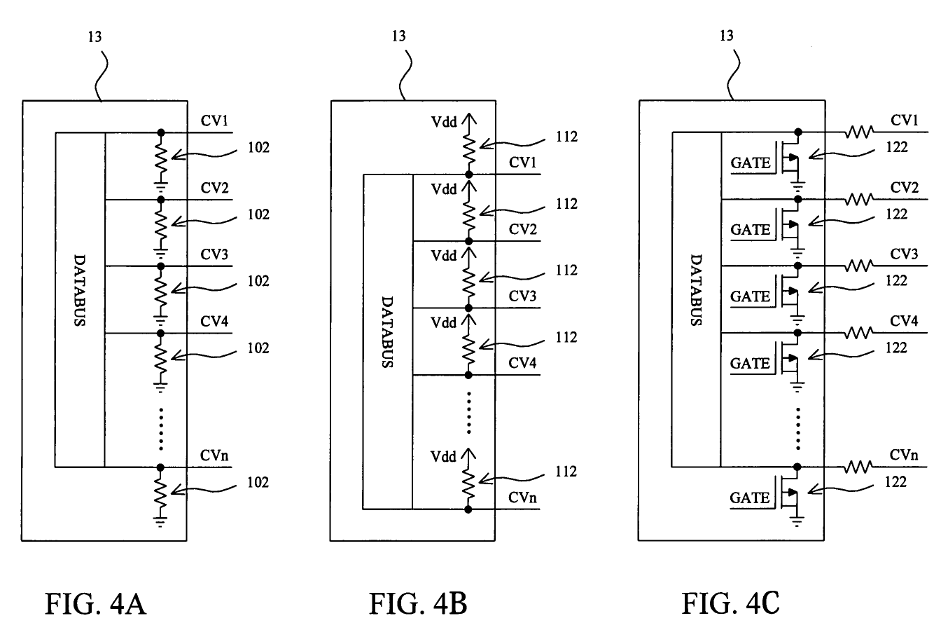

FIG. 4 shows various embodiments for the pin option circuit 13 to determine the configuration of the pins CV1-CVn. In FIG. 4A, each of the pins CV1-CVn is connected with a pull-down resistor 102, such that each one of them will have a state of ‘0’ if it is floating. If each of the pins CV1-CVn is at the state of ‘0’, the offset is 0, and the DV value will be the original setting. To tune the contrast voltages for the LCD, the pins CV1-CVn are selectively connected with supply voltage Vdd by the jumpers 58 to change the state thereon from ‘0’ to ‘1’, so as to change the offset for the DV register18. Alternatively, the pin option circuit 13 shown in FIG. 4B has the pins CV1-CVn originally configured with ‘1111’ by connecting each one of them with a pull-up resistor 112, and in this case, the offset is 0 when the configuration is “1111’. To tune the contrast voltages for the LCD, the pins CV1-CVn are selectively connected to ground by the jumpers 58 to change the state thereon from ‘1’ to ‘0’, and the offset is thus determined. In either FIG. 4A or FIG. 4B, each of the pins CV1-CVn has two states, ‘0’ and ‘1’, to be defined, and more states can be provided for them in other embodiments. For example, FIG. 4C shows one has each of the pins CV1-CVn connected to an open-drain MOS circuit 122, by which the pins CV1-CVn can be selectively to be the state of ‘1’, ‘0’ or floating by connecting them to supply voltage Vdd or ground with the jumpers 58 or leaving them floating.

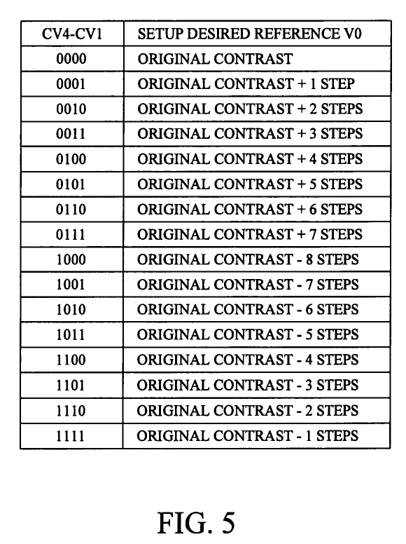

FIG. 5 shows an example for the circuit shown in FIG. 4A to tune the reference V0 by configuring the pins CV1-CV4. When all the pins CV1-CV4 are at the state of ‘0’, the offset is 0, whose binary representation is ‘0000’, and the reference V0 will be the one determined by the original setting stored in the register 16. If the pin V1 is connected to a supply voltage Vdd by a jumper 58, its state becomes ‘1’, and the offset will be ‘0001’ in binary representation, which is to set the reference V0 to be the original setting plus one step. The resolution of tuning the reference V0 is the voltage difference resulted from one step, and the range of the reference V0 to be defined is from the original setting decreased with 8 steps to the original setting increased with 7 steps. In this embodiment, the reference V0 or the contrast voltages V0-V4 are increased or decreased from the original setting by configuring the pins CV1-CV4 with the jumpers 58.

If the tuning apparatus has four pins, CV1-CV4, and the pin option circuit 13 employs pull-down resistors, the tuning operation comprises a hardware reset for initialization of the LCD driver 54, calibration and displaying of test pattern on the screen, observation of the contrast of the displayed picture for an optimized performance, and recording the value for the optimized contrast performance with the offset
δ=V0(optimized)−V0(original setting). [EQ-1]
The value corresponding to the configuration of the pins CV1-CV4 may be determined from the equation EQ-1. Once the states of the pins CV1-CV4 are determined, the jumpers 58 can be connected to the respective pins.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. An apparatus for tuning a plurality of contrast voltages for a liquid crystal display, comprising:
a plurality of pins configured for determining an offset; and
a variable voltage generator for generating a reference for the plurality of contrast voltages based on a summation of the offset and an original setting.

2. The apparatus of claim 1, wherein the plurality of pins have each one of them being one of two states.

3. The apparatus of claim 1, wherein the plurality of pins have each one of them being one of three states.

4. The apparatus of claim 1, wherein the plurality of pins have each one of them being one of a plurality of states.

5. The apparatus of claim 1, further comprising a register for storing the offset.

6. The apparatus of claim 1, further comprising a register for storing the original setting.

7. The apparatus of claim 1, further comprising a combiner for generating the summation by combining the offset with the original setting.

8. The apparatus of claim 1, further comprising a register for storing the summation.

9. The apparatus of claim 1, wherein the variable voltage generator comprises:
a voltage source for supplying a voltage; and
a variable resistor connected with the voltage for being tuned to have a resistance thereof based on the summation to thereby generate the reference.

10. The apparatus of claim 1, further comprising a voltage divider connected with the reference for generating the plurality of contrast voltages.

11. The apparatus of claim 1, further comprising a pin option circuit for determining an initial configuration of the plurality of pins.

12. The apparatus of claim 11, wherein the pin option circuit comprises a plurality of pull-down resistors each connected to a respective one of the plurality of pins.

13. The apparatus of claim 11, wherein the pin option circuit comprises a plurality of pull-up resistors each connected to a respective one of the plurality of pins.

14. The apparatus of claim 11, wherein the pin option circuit comprises a plurality of open-drain MOS circuits each connected to a respective one of the plurality of pins.

15. The apparatus of claim 5, further comprising a switch inserted between the plurality of pins and register for transferring the offset into the register under a control of a reset signal.

16. The apparatus of claim 15, wherein the reset signal comprises a positive impulse.

17. The apparatus of claim 15, wherein the reset signal comprises a negative impulse.

18. A method for tuning a plurality of contrast voltages for a liquid crystal display, comprising the steps of:
determining an offset by a configuration of a plurality of pins; and
generating a reference for the plurality of contrast voltages based on a summation of the offset and an original setting.

19. The method of claim 18, wherein the step of determining an offset comprises the steps of:
switching a switch between the plurality of pins and a register by a reset signal; and
transferring the offset determined by the plurality of pins into the register.

20. The method of claim 18, further comprising storing the original setting into a register.

21. The method of claim 18, further comprising generating the summation by combining the offset with original setting.

22. The method of claim 18, further comprising storing the summation into a register.

23. The method of claim 18, wherein the step of generating a reference comprises the steps of:
providing a supply voltage to a variable resistor; and
tuning the variable resistor for determining a resistance thereof based on the summation to thereby generate the reference.

24. The method of claim 23, further comprising dividing the reference for generating the plurality of contrast voltages.

25. The method of claim 18, further comprising determining the configuration by a pin option circuit connected to the plurality of pins.
